(19) United States
(12) Patent Application Publication
(10) Pub. No.: US 2019/0040958 A1
(43) Pub. Date: Feb. 7, 2019

(54) Shaft Slide Ring Seal Arrangement

(71) Applicant: NETZSCH Pumpen & Systeme GmbH, Selb (DE)

(72) Inventors: Johann Kreidl, Waldkraiburg (DE); Hisham Kamal, Waldkraiburg (DE); Mikael Tekneyan, Kraiburg am Inn (DE); Philipp Nuebl, Gras Bahnhof (DE)

(21) Appl. No.: 15/759,058

(22) PCT Filed: Sep. 1, 2016
(86) PCT No.: PCT/DE2016/000336

§ 371 Date: Mar. 9, 2018

(30) Foreign Application Priority Data
Sep. 9, 2015 (DE) 102015011808.0

(51) Int. Cl. F16J 15/34; F04C 27/00

(52) U.S. Cl. CPC F16J 15/3472; F04C 27/005

(57) ABSTRACT

A shaft slide ring seal arrangement including a shaft, which has a first and second end, and a slide ring seal, which includes a shaft slide ring connected non-rotatably to the shaft, the axial displaceability whereof is limited at least in the direction of the first end of the shaft by a limiting element, and a slide ring arrangement arranged at a radial distance from the shaft, which slide ring arrangement lies, at a side of the shaft slide ring pointing towards the second end of the shaft, axially adjacent thereto, as well as a retaining ring supported on the shaft, the axial displaceability whereof is limited at least in the direction of the second end of the shaft and which centers the slide ring arrangement, on its side facing away from the shaft slide ring, with respect to the shaft.

### TECHNICAL FIELD

The invention relates to a shaft slide ring seal arrangement and a drivetrain section and to an eccentric screw pump with a shaft slide ring seal arrangement.

### BACKGROUND

A shaft slide ring seal arrangement is known from US 2006/0061041 A1. The latter makes provision such that a shaft sleeve is pushed onto a shaft and is connected at one end of the shaft sleeve to the shaft non-rotatably by means of screws, which are passed radially through a stop ring additionally fitted on the shaft sleeve. Located at the other end of the shaft sleeve is a pushed-on shaft slide ring, which is connected non-rotatably to the shaft sleeve and, by means of a spring ring element, is pretensioned in the direction of the stop ring against a slide ring arrangement radially spaced apart from the shaft sleeve. In order that the slide ring arrangement, for example during transport, does not reach the stop ring and that at the same time a centering operational pretension is maintained, positioning hooks are provided which are fixed to the stop ring by the radial screws and engage into a corresponding circumferential groove in the slide ring arrangement. These positioning hooks are used solely during transport or during installation or removal of the shaft slide ring seal arrangement in a drivetrain. Once installed, a spacing between the fixed slide ring arrangement and the stop ring is maintained, in that the slide ring arrangement is screwed to a fixed housing, so that the positioning hooks can be removed.

Further relevant prior art can be found in German patent specification DE 10 2013 101 185 B4.

### SUMMARY

The problem of the invention is to make available a shaft slide ring seal arrangement which reliably prevents jamming and/or wedging of the slide ring seal.

According to the invention, this problem is solved by a shaft slide ring seal arrangement which comprises the features of the invention.

A shaft slide ring seal arrangement according to the invention comprises a shaft, which has a first end and a second end, and a slide ring seal, which comprises a shaft slide ring connected non-rotatably to the shaft, the axial displaceability whereof is limited at least in the direction of the first end of the shaft by means of a limiting element, and a slide ring arrangement arranged at a radial distance from the shaft, which slide ring arrangement lies, at a side of the shaft slide ring pointing towards the second end of the shaft, axially adjacent thereto, and also a retaining ring supported on the shaft, the axial displaceability whereof is limited at least in the direction of the second end of the shaft and which centers the slide ring arrangement, on its side facing away from the shaft slide ring, with respect to the shaft. In this way, the slide ring seal can remain on the shaft when the shaft is installed in and removed from a drivetrain. In other words, the slide ring seal does not need to be dismantled in order to be able to remove the shaft from a device. The retaining ring thus keeps the slide ring arrangement centered with respect to the shaft in every operational state of the shaft and thus automatically prevents jamming or wedging of the slide ring arrangement.

The retaining ring advantageously has a face pointing towards the slide ring arrangement and descending towards the shaft longitudinal axis. In this way, the centering of the slide ring arrangement is facilitated when the retaining ring is fitted and, moreover, centering of an assembled shaft slide ring seal arrangement thus automatically takes place. According to an example of embodiment, the face used for the centering is an annular face tapering conically.

The slide ring arrangement can comprise one element, but it is particularly advantageous for the slide ring arrangement to comprise a slide ring and a slide ring holder, wherein the slide ring holder is connecting non-rotatably to the slide ring and the shaft slide ring is mounted axially spring-loaded with respect to the limiting element. Standardized slide rings can thus be used, which can be adapted to different shaft slide ring seal arrangements by means of application-specific slide ring holders.

It is also advantageous if the retaining ring axially pretensions the slide ring seal, as a result of which the contact between the retaining ring and the slide ring arrangement as well as a corresponding automatic centering is ensured.

Furthermore, it is advantageous for the slide ring seal to be displaceable relative to the limiting element by release of the retaining ring, in order to be able to increase the pretensioning further. With a retaining ring fixedly connected to the shaft and which rotates with the shaft, a gap between the retaining ring and the slide ring arrangement can thus be created in the installed state of the shaft slide ring seal arrangement, said gap preventing friction between the rotating retaining ring and the fixed slide ring arrangement, and the required operational pretensioning in the slide ring seal nonetheless being achieved.

A shaft slide ring seal arrangement is also advantageous, wherein the slide ring arrangement is held in its position centered on the retaining ring by means of a retaining element. This retaining element is used in a difficult installation and removal situation and/or with very heavy components and, when threading the shaft slide ring seal arrangement into a device, offers additional safeguarding against slipping or wedging of the slide ring seal. These retaining elements are thus used only for the installation or removal and are removed again for the operation.

The invention also related to a drivetrain section with a drive shaft, a shaft ring seal arrangement following the latter as described above and a receiving device surrounding the shaft slide ring seal arrangement in a fixed manner, wherein the receiving device is concentric with respect to the drive shaft and receives the slide ring arrangement non-rotatably, and wherein the receiving device is arranged at a fixed axial distance from the drive shaft. Such a drivetrain section facilitates the introduction and securing of the shaft slide ring seal arrangement, wherein at the same time the slide ring arrangement is fixed by the receiving device, so that a rotation of the shaft brings about a relative movement of the shaft slide ring with respect to the slide ring arrangement and the slide ring.

In the drivetrain section, it is advantageous if the receiving device and the drive shaft limit an axial displacement of the slide ring seal away from the limiting element. Slipping of the shaft slide ring seal arrangement through the receiving device can thus be prevented. Moreover, with a retaining ring connected fixedly to the shaft and which rotates with the shaft, a gap can thus be created between the retaining ring and the slide ring arrangement, said gap preventing friction between the rotating retaining ring and the fixed slide ring arrangement, and the required operational pretensioning between the shaft slide ring and the slide ring can nonetheless be achieved.

It is particularly advantageous if a radial opening in the shaft and a radial opening in the drive shaft do not become aligned with one another until a predetermined operational pretensioning of the slide ring seal is reached. With a retaining ring connected non-rotatably to the shaft, the gap between the retaining ring and the slide ring arrangement is thus already automatically created when the shaft slide ring seal arrangement is installed, and the shaft can only then be connected to the drive shaft whereby a safety pin is inserted into the mutually aligned openings.

The above shaft slide ring seal arrangement or the drivetrain section are advantageously used in an eccentric screw pump. In the latter, a rapid and uncomplicated installation and removal is particularly important, so that for this purpose the shaft slide ring seal arrangement can be dismantled as a unit comprising the shaft and the slide ring seal and can, if desired, only be split up into its individual parts following dismantling.

### BRIEF DESCRIPTION OF THE DRAWINGS

The invention is explained below with the aid of diagrammatic drawings. In the figures:

FIG. 1 shows an example of embodiment of a shaft slide ring seal arrangement according to the invention in a receiving device,

FIG. 2 shows section A-A from FIG. 1 with a symbolically represented drive shaft, and

FIG. 3 shows a perspective exploded view of the shaft slide ring seal arrangement with the receiving device according to FIGS. 1 and 2.

### DETAILED DESCRIPTION

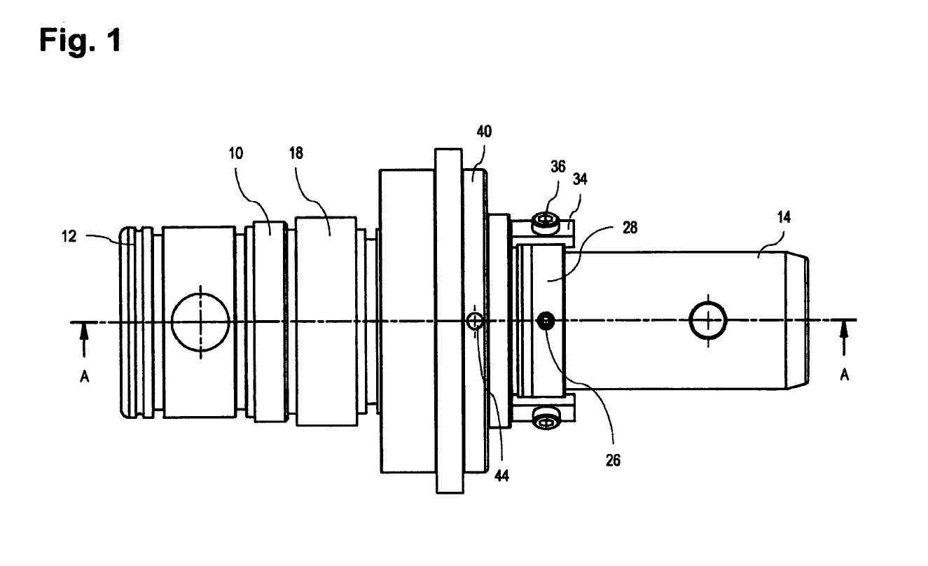

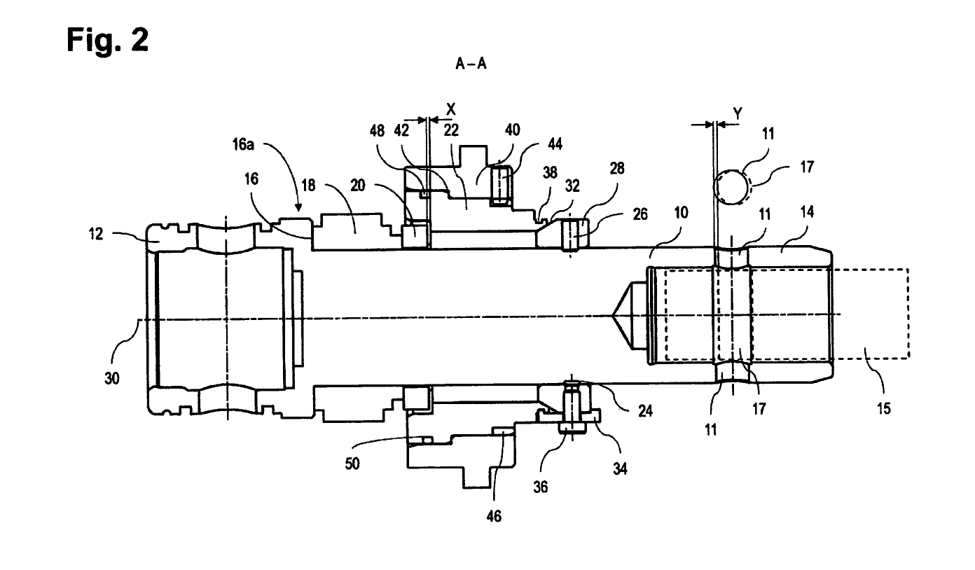

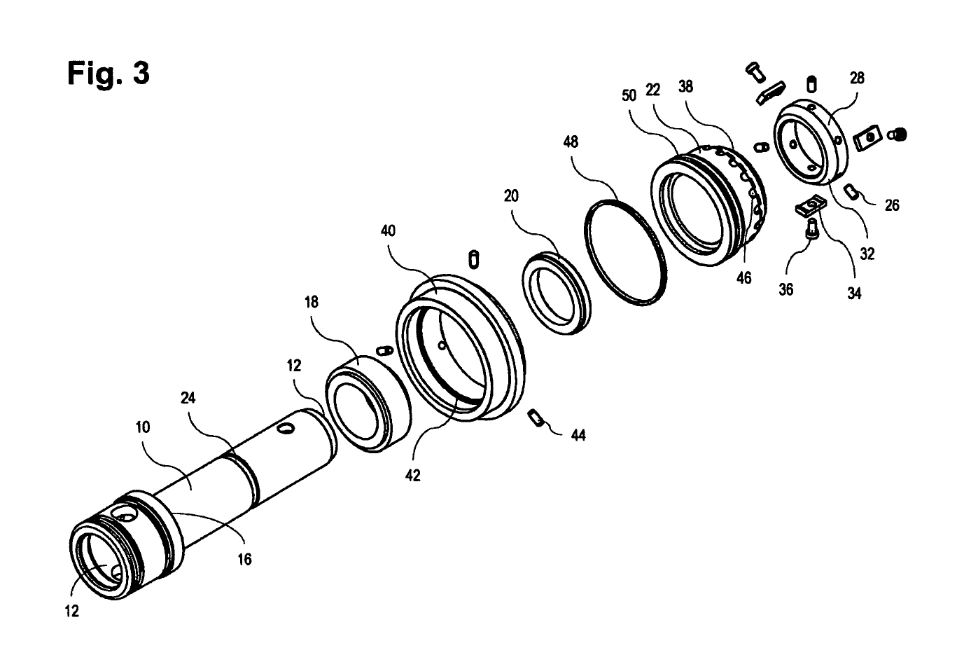

FIG. 1 shows a shaft slide ring seal arrangement according to the invention, the individual parts whereof can best be seen in section A-A in FIG. 2 and in the perspective exploded view end FIG. 3.

The shaft ring seal arrangement comprises a shaft 10, which at its first end 12 comprises an articulated socket and at its second end 14 comprises a socket for a driveshaft 15. Furthermore, the shaft slide ring seal arrangement comprises, viewed from left to right in FIG. 2, a shaft slide ring 18 connecting non-rotatably to shaft 10 and lying adjacent to a limiting element 16a constituted as a shaft shoulder 16, a slide ring 20 pushed onto the shaft at a radial distance, a slide ring holder 22 holding slide ring 20 and pushed on at a greater radial distance from the shaft 10, as well as a retaining ring 28 connected to shaft 10 by means of shaft groove 24 via pins 26, which retaining ring comprises an annular face 32 inclined towards shaft longitudinal axis 30, with which annular face it lies against a complementary face of slide ring holder 22. Slide ring 20 and slide ring holder 22 form a slide ring arrangement 20, 22. Furthermore, shaft slide ring 18 and slide ring arrangement 20, 22 form a slide ring seal 18, 20, 22. Not shown, but indicated by a gap X, is a spring element also belonging to slide ring arrangement 20, 22, said spring element being in the form of sinusoidal springs fitted onto the shaft or in the form of helical springs arranged running around the shaft, which spring element lies between slide ring 20 and slide ring holder 22 and supports the latter axially spring-loaded with respect to one another.

Entire slide ring seal 18, 20, 22 is thus enclosed between a shaft shoulder 16 and retaining ring 28 and held on shaft 10. The position of retaining ring 28 on shaft 10 is selected by means of an axial spacing of a shaft groove 24 from shaft shoulder 16, in such a way that slide ring seal 18, 20, 22 acquires a pretension and slide ring holder 22 remains in contact with retaining ring 28 and centered with respect to shaft 10. In order to secure this during transport or during installation and removal of the shaft slide ring seal arrangement, retaining elements 34 constituted as retaining clamps 34 are provided in the example of embodiment, said retaining elements being fastened by means of screws 36 to retaining ring 28, in such a way that they engage in a complementary hook-shaped end of slide ring holder 22 in the form of a retaining element groove 38, in order to secure slide ring holder 22 to retaining ring 28. These retaining clamps 34 are required in particular in the presence of especially difficult installation and removal conditions and in the case of particularly heavy and large components and even then are provided only for the installation and removal of the shaft slide ring seal arrangement.

For the assembly of the shaft slide ring seal arrangement, shaft slide ring 18 is first pushed onto shaft 10 until it lies against shaft shoulder 16; slide ring arrangement 20, 22 is then pushed onto shaft 10 and brought into contact with shaft slide ring 18; retaining ring 28 is then pushed on and its inclined face 32 is pressed against the face of slide ring holder 22 inclined in a complementary manner, in order to push retaining ring 28 over shaft groove 24, after which it is fixed axially on shaft 10 by means of pins 26 engaging in shaft groove 24.

For the assembly of the shaft slide ring seal arrangement in a drivetrain section, the former is pushed axially into a receiving device 40. Receiving device 40 here is a ring with a stepped inner periphery that projects out of a non-rotatable housing, as a result of which a receiving shoulder 42 is formed, which defines the end position of the shaft slide ring seal arrangement and prevents a further axial displacement of the shaft slide ring seal arrangement. For the non-rotatable securing of the shaft slide ring seal arrangement to receiving device 40, pins 44 in receiving device 40 or alternatively projections on receiving device 40 are provided, which project radially inwards and engage in corresponding circumferential axial grooves 46 on the outer side of slide ring holder 22. Consequently, the present non-rotatable securing is a form-fit contact between slide ring holder 22 and receiving device 40.

An O-ring seal 48 is provided in an outer O-ring groove 50 of slide ring holder 22 for the seal between slide ring holder 22 and receiving device 40.

In order to connect shaft 10 to a drive shaft 15 (FIG. 2), shaft 10, proceeding from the state represented in FIG. 2, must be pressed against receiving shoulder 42 or against pins 44 by means of slide ring arrangement 18, 20, 22, so that a gap arises between retaining ring 28 and slide ring holder 22 in the assembled state (not shown) on account of the spring-loaded support of slide ring 20. At the same time, an initial offset Y between radial openings 11 in shaft 10 and a radial opening 17 in drive shaft 15 is thus overcome, so that openings 11, 17 are aligned with one another. This initial offset Y is also represented in FIG. 2 by means of two circles over second end 14 of shaft 10, wherein the circles symbolize respective openings 11, 17 in a plan view onto shaft 10. Only when offset Y has been overcome, i.e. is no longer present, can a connecting bolt (not represented) be pushed through openings 11, 17 in order to connect the two shafts 10, 15 together. Gap X and offset Y are subject to the following relationship: X>Y.

Drive shaft 15 and its radial opening 17 are represented with a dashed line in FIG. 2. Openings 11 of shaft 10 have the same diameter as opening 17 in drive shaft 15. The unbroken parallel lines extending between openings 11 show the width of an annular groove, which arises at the inner circumferential surface of second end 14 of the shaft 10 on account of a burr-removing process. When shaft 10 is separated from drive shaft 15, slide ring holder 22 springs back into the form-fit connection with inclined face 32 of retaining ring 28, so that slide ring arrangement 20, 22 automatically remains centered during removal of the shaft slide ring seal arrangement from receiving device 40.

Individual advantageous modifications are explained below, which can be provided individually with or instead of the features described above.
The axial displaceability of shaft slide ring 18 is limited at least in the direction of first end 12 of shaft 10, advantageously by shaft shoulder 16. Shaft shoulder 16 represents a stop, which enables a rapid and straightforward assembly. This at least one-sided limitation of the displaceability can also be effected by a locking ring pushed on from first end 12 of shaft 10, so that the shaft shoulder 16 can be dispensed with. Shaft 10 can thus be constituted essentially cylindrical, which simplifies the production of shaft 10 and saves shaft material. Furthermore, shaft slide ring 18 can also be fastened to a shaft 10 without a shaft shoulder 16 so as to be axially non-displaceable in both directions by means of a releasable fastening element, e.g. pins or screws. Shaft slide ring 18 would thus remain on shaft 10 during the opening of slide ring seal 18, 20, 22 by removing retaining ring 28. The same considerations also apply analogously to retaining ring 28, the axial displaceability whereof must be limited at least in the direction of second end 14 of shaft 10.
Retaining ring 28 centers slide ring arrangement 20, 22 by means of a face pointing towards slide ring arrangement 20, 22 and descending towards a shaft longitudinal axis 30. The descending face is advantageously a beveled face, which is straightforward in its production. Concave or convex faces are however also possible, said faces being able to be selected according to the desired centering properties.
Slide ring arrangement 20, 22 advantageously comprises, in addition to slide ring 20 and slide ring holder 22, a spring element which is arranged between the two. The latter serves to pretension slide ring 20 against shaft slide ring 18 in order to achieve an operation-specific sealing. The spring element is advantageously constituted by one or more sinusoidal springs, which like the other elements are slipped onto shaft 10, since they can thus be selected and replaced in a straightforward manner and in accordance with the required spring properties. Helical springs are also low-cost, which are fitted to slide ring holder 22 running around shaft 10 and extend axially to slide ring 20.
As a result of the fact that retaining ring 28 axially pretensions slide ring 20 of slide ring arrangement 20, 22 against shaft slide ring 18, a basic pretensioning can be achieved for the automatic centering. Advantageously, operational pretensioning can also be achieved by the fact that retaining ring 28 is mounted rotatably relative to the shaft and is capable of jointly rotating with slide ring arrangement 20, 22 on account of the frictional engagement of face 32 descending towards the shaft longitudinal axis with the complementary face on slide ring holder 22. This is achieved for example by means of a two-part retaining ring 28 (not represented), the inner ring whereof is connected non-rotatably to shaft 10 and the outer ring whereof, which comprises descending face 32, is mounted rotatably on the inner ring. The provision of a spacing between retaining ring 28 and slide ring holder 22 of slide ring arrangement 20, 22 in the operational state thus becomes unnecessary.
It is advantageous, for example in the case of a retaining ring 28 jointly rotating with shaft 10, for slide ring arrangement 20, 22 to be displaceable relative to shaft slide ring 18 by release of retaining ring 28, in order to increase further the pretensioning and to achieve the operational pretensioning, wherein at the same time a spacing in the form of a gap is created between retaining ring 28 and slide ring holder 22 of slide ring arrangement 20, 22. As a result of a lesser pretensioning of the shaft slide ring seal arrangement during transport and storage, the slide ring seal can thus be protected and safeguarded against premature wear.
The combination of a retaining ring 28 with a descending face for the centering and a retaining element 34, which is capable of keeping slide ring holder 22 of slide ring arrangement 20, 22 centered with respect to shaft 10, is particularly advantageous, since the centering is achieved not only by the retaining element(s), but is already present beforehand, so that jamming of slide ring arrangement 20, 22 is already eliminated when the retaining element(s) is fitted.
According to a variant, receiving shoulder 42 can be dispensed with and the axial limitation can be secured solely by means of pins 44 located in axial grooves 46, wherein axial groove 46 must then, as shown in FIG. 3, have a stop, i.e. must not be continuous. The latter would however be possible if the operational pretensioning were already achieved by means of a retaining ring 28 rotating relative to shaft 10. Furthermore, O-ring groove 50 with corresponding O-ring 48 can also be arranged in the inner circumferential face of receiving device 40.
Alternatively, instead of slide ring 20, shaft slide ring 18 is mounted in an axially spring-loaded manner with respect to limiting element 16a in the manner described above, so that an axially spring-loaded mounting between slide ring 20 and slide ring holder 22 can be dispensed with.

1. A shaft slide ring seal arrangement, comprising
a shaft, which has a first end and a second end, and
a slide ring seal, which includes:
a shaft slide ring connected non-rotatably to the shaft, the axial displaceability whereof is limited at least in the direction of the first end of the shaft by means of a limiting element, and
a slide ring arrangement arranged at a radial distance from the shaft, which slide ring arrangement lies, at a side of the shaft slide ring pointing towards the second end of the shaft, axially adjacent thereto, wherein
a retaining ring supported on the shaft, the axial displaceability whereof is limited at least in the direction of the second end of the shaft and which centers the slide ring arrangement, on its side facing away from the shaft slide ring, with respect to the shaft.

2. The shaft slide ring seal arrangement according to claim 1,
wherein the retaining ring has a face pointing towards the slide ring arrangement and descending towards the shaft longitudinal axis.

3. The shaft slide ring seal arrangement according to claim 1,
wherein the slide ring arrangement includes a slide ring and a slide ring holder, wherein the slide ring holder is connecting non-rotatably to the slide ring and the shaft slide ring is mounted axially spring-loaded with respect to the limiting element.

4. The shaft slide ring seal arrangement according to claim 1,
wherein the retaining ring axially pretensions the slide ring seal.

5. The shaft slide ring seal arrangement according to claim 4,
wherein the slide ring seal is displaceable relative to the limiting element by release of the retaining ring, in order to be able to increase the pretensioning further.

6. The shaft slide ring seal arrangement according to claim 1,
wherein the slide ring arrangement is held in its position centered on the retaining ring by means of a retaining element.

7. A drivetrain section with a drive shaft, a following shaft ring seal arrangement comprising
a shaft, which has a first end and a second end, and
a slide ring seal, which includes:
a shaft slide ring connected non-rotatably to the shaft, the axial displaceability whereof is limited at least in the direction of the first end of the shaft by means of a limiting element, and
a slide ring arrangement arranged at a radial distance from the shaft, which slide ring arrangement lies, at a side of the shaft slide ring pointing towards the second end of the shaft, axially adjacent thereto, wherein
a retaining ring supported on the shaft, the axial displaceability whereof is limited at least in the direction of the second end of the shaft and which centers the slide ring arrangement, on its side facing away from the shaft slide ring, with respect to the shaft;
and a receiving device surrounding the shaft slide ring seal arrangement in a fixed manner, wherein the receiving device is concentric with respect to the drive shaft and receives the slide ring arrangement non-rotatably, and wherein the receiving device is arranged at a fixed axial distance from the drive shaft.

8. The drivetrain section according to claim 7,
wherein the receiving device and the drive shaft limit an axial displacement of the slide ring seal away from the limiting element.

9. The drivetrain section according to claim 7,
wherein a radial opening in the shaft and a radial opening in the drive shaft do not become aligned with one another until a predetermined operational pretensioning of the slide ring seal is reached.

10. An eccentric screw pump with a shaft slide ring seal arrangement or a drivetrain section including:
a shaft, which has a first end and a second end, and
a slide ring seal, which includes:
a shaft slide ring connected non-rotatably to the shaft, the axial displaceability whereof is limited at least in the direction of the first end of the shaft by means of a limiting element, and
a slide ring arrangement arranged at a radial distance from the shaft, which slide ring arrangement lies, at a side of the shaft slide ring pointing towards the second end of the shaft, axially adjacent thereto, wherein
a retaining ring supported on the shaft, the axial displaceability whereof is limited at least in the direction of the second end of the shaft and which centers the slide ring arrangement, on its side facing away from the shaft slide ring, with respect to the shaft.

11. The shaft slide ring seal arrangement according to claim 2, wherein the slide ring arrangement includes a slide ring and a slide ring holder, wherein the slide ring holder is connecting non-rotatably to the slide ring and the shaft slide ring is mounted axially spring-loaded with respect to the limiting element.

12. The shaft slide ring seal arrangement according to claim 2, wherein the retaining ring axially pretensions the slide ring seal.

13. The shaft slide ring seal arrangement according to claim 2, wherein the slide ring arrangement is held in its position centered on the retaining ring by means of a retaining element.

14. The drivetrain section according to claim 8, wherein a radial opening in the shaft and a radial opening in the drive shaft do not become aligned with one another until a predetermined operational pretensioning of the slide ring seal is reached.
